(19) United States
(12) Patent Application Publication
(10) Pub. No.: US 2007/0136423 A1
(43) Pub. Date: Jun. 14, 2007

(54) Methods, systems, and media for managing a collaboration space

(76) Inventors: Alan R. Gilmore, Holywood (GB); Mark Greatorex, Reading (IE); Fergus M. Wilson, Saintfield (GB)

Correspondence Address: WILMER CUTLER PICKERING HALE AND DORR LLP, 399 PARK AVENUE, NEW YORK, NY, 10022, US

(21) Appl. No.: 11/603,683

(22) Filed: Nov. 22, 2006

Related U.S. Application Data
(60) Provisional application No. 60/739,367, filed on Nov. 23, 2005.

(51) Int. Cl. G06F 15/16

(52) U.S. Cl. 709/204

(57) ABSTRACT

Methods, systems, and media for managing a collaboration space are provided. In some embodiments, methods for managing a collaboration space are provided, comprising: defining an event related to the collaboration space; and upon occurrence of the event, performing at least one of automatically cleaning-up the collaboration space, cataloguing the collaboration space, and updating a catalog including the collaboration space.

### CROSS-REFERENCE TO RELATED APPLICATION

This application claims the benefit of United States Provisional Patent Application No. 60/739367, filed Nov. 23, 2005, which is hereby incorporated by reference herein in its entirety.

### TECHNICAL FIELD

The invention relates to systems and methods for management of disparate Collaboration Spaces using an Event Handling Mechanism to create and extract Metadata from the Collaboration Space and send such Metadata to an Electronic Documents and Records Management System (EDRMS). The EDRMS is then able to use the Metadata to create a system-wide overview of the existence, nature and type of Collaboration Spaces and/or to create a transparent interface to EDRMS users as to what information is contained in the Collaboration Spaces.

### BACKGROUND

In many modem organizations there are one or more systems which exist to enable users to collaborate in the creation of documents and other electronic records. Users with similar responsibilities in different locations may need to collaborate on a single item. Rather than sending the item around via e-mail, the users may use a software program such as IBM's Lotus Notes or Microsoft's SharePoint to create a central location where the item may be located; these locations are sometimes referred to as “Collaboration Spaces.” A user may easily create a Collaboration Space which allows disparate users to access the item, irrespective of where those users are located.

As mentioned above, one significant advantage of these systems is the ease with which users may create Collaboration Spaces. This advantage is at the same time one of the major disadvantages of these systems. Collaboration Spaces proliferate throughout an organization, and there is no simple automatic method of cataloguing, indexing and ultimately disposing of such Collaboration Spaces once they have outlived their usefulness. In order to maintain such a catalogue, someone within the organization must be tasked with surveying the Collaboration Spaces and manually creating such an index. In addition, this individual must contact the users of a Collaboration Space periodically to determine whether the Collaboration Space is still in use; if not, he must manually delete the Collaboration Space.

There exists then a need for a system which can manage the creation, existence and content of Collaboration Spaces.

### SUMMARY

Methods, systems, and media for managing a collaboration space are provided. In some embodiments, methods for managing a collaboration space are provided, comprising: defining an event related to the collaboration space; and upon occurrence of the event, performing at least one of automatically cleaning-up the collaboration space, cataloguing the collaboration space, and updating a catalog including the collaboration space.

In some embodiments, systems for managing a collaboration space are provided, comprising: a processor that: receives a definition of an event related to the collaboration space; and upon occurrence of the event, performs at least one of automatically cleaning-up the collaboration space, cataloguing the collaboration space, and updating a catalog including the collaboration space.

In some embodiments, computer-readable media containing computer-executable instructions that, when executed by a processor, cause the processor to perform a method for managing a collaboration space, the method comprising: defining an event related to the collaboration space; and upon occurrence of the event, performing at least one of automatically cleaning-up the collaboration space, cataloguing the collaboration space, and updating a catalog including the collaboration space.

### BRIEF DESCRIPTION OF DRAWINGS

The present invention is further described below in connection with the drawings. One skilled in the art will readily recognize from the discussion herein that alternative embodiments of the structures and methods illustrated herein may be employed without departing from the principles of the invention described herein:

FIG. 1 illustrates the creation of a catalogue of Collaboration Spaces within the EDRMS in accordance with some embodiments of the present invention;

FIG. 2 illustrates the creation of an overview of certain predefined information on Collaboration Spaces in accordance with some embodiments of the present invention;

FIG. 3 illustrates automatically deletion of a Collaboration Space on the happening of one or more predefined events in accordance with some embodiments of the present invention; and

FIG. 4 illustrates applying the Records Management Policies from an EDRMS to individual Collaboration Spaces in accordance with some embodiments of the present invention.

### DETAILED DESCRIPTION

In accordance with some embodiments of the invention, an Event Handling Mechanism that exists within one or more disparate Collaboration Systems can be provided. The Event Handling Mechanism instructs the Collaboration System, upon the happening of a predetermined event such as creation of the Collaboration Space, to extract and send to the EDRMS certain metadata meeting criteria that have been determined in advance by an Administrator. Upon receipt of the Metadata, the EDRMS then creates a catalogue of the Collaboration Spaces within the Collaboration System; this catalogue can then be used by the EDRMS in at least two ways. First, it can be used to present the Administrator and/or Users of the EDRMS with a view as to what Collaboration Spaces exist within the Collaboration Systems and the nature and purpose of the spaces, as well as an indication of their useful life. Second, the catalogue can be used to present an EDRMS user with a common interface to records that exist within the Collaboration Spaces and the ability to navigate into and between Collaboration Spaces. Upon occurrence of the same or another event, the Event Handling Mechanism can additionally or alternatively take any other suitable action, such as, for example, rolling up a collaboration space after a period of inactivity.

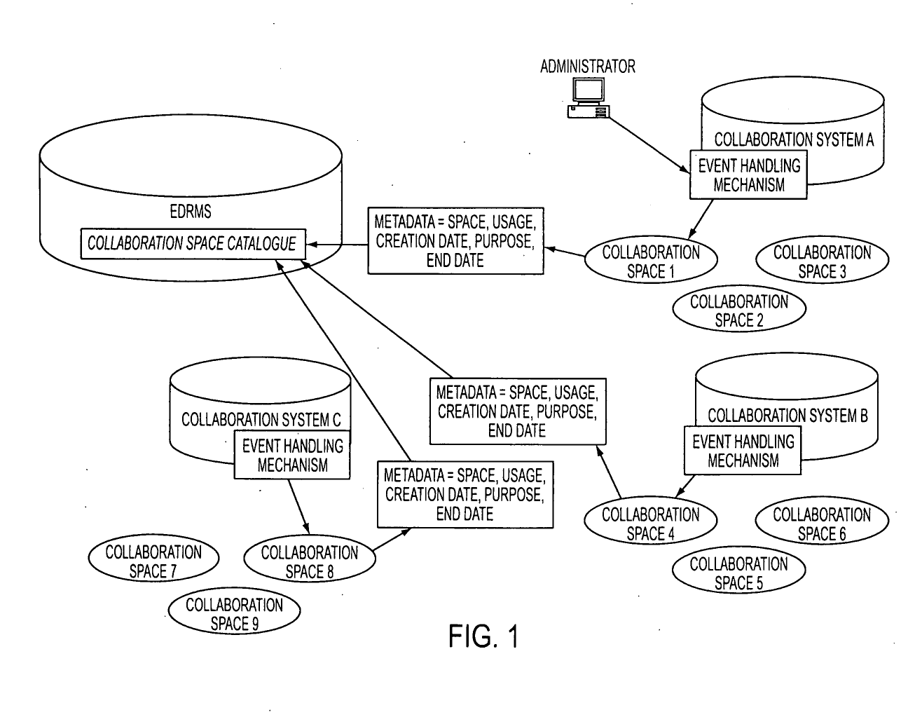

Referring now to FIG. 1, one embodiment of the invention is illustrated. As shown, for Collaboration Systems which have an internal Event Handling Mechanism, the Administrator may first instruct the internal Event Handling Mechanism to extract certain Metadata on the happening of a predefined event. In the illustrated example, he has instructed the Event Handling Mechanism in Collaboration System A to perform certain actions upon the creation of a Collaboration Space. Particularly, he has instructed the Event Handling Mechanism to extract from the Collaboration Space the following information; the Collaboration Space's usage, the creation date, the purpose of the collaboration space and the end date (if any). He may additionally or alternatively instruct the mechanism to extract any other suitable information. As in the illustrated example, the Collaboration Space may have an internal Event Handling Mechanism, as is the case with Collaboration Systems such as Microsoft's SharePoint. However, other Collaboration Systems may not have such an internal Event Handling Mechanism. In such a case, the Administrator may then use a different set of tools to create an Event Handling Mechanism which is applied to the Collaboration System to perform the same actions as would be the case where the Event Handling Mechanism is already internal to the Collaboration System.

Users of the Collaboration System may now create Collaboration Spaces. Upon the happening of this event, the Event Handling Mechanism may query the newly created Collaboration Space and extract the Metadata predefined by the Administrator. It then passes the information to the EDRMS which uses the Metadata to compile a catalogue of Collaboration Spaces. This catalogue can be used by the Administrator to maintain an inventory of existing Collaboration Spaces. Alternatively, this Catalogue could be made available to users of any of the Collaboration Systems to show these users what Collaboration Spaces already exist, thereby potentially reducing the number of overlapping or redundant Collaboration Spaces. Additionally or alternatively, a user could be provided with the ability to browse or search a catalogue of existing collaboration spaces prior to creating a new collaboration space in order to allow the user to determine whether a suitable collaboration space already exists. In some embodiments, a user may be prevented from creating a collaboration space until such a catalogue is reviewed.

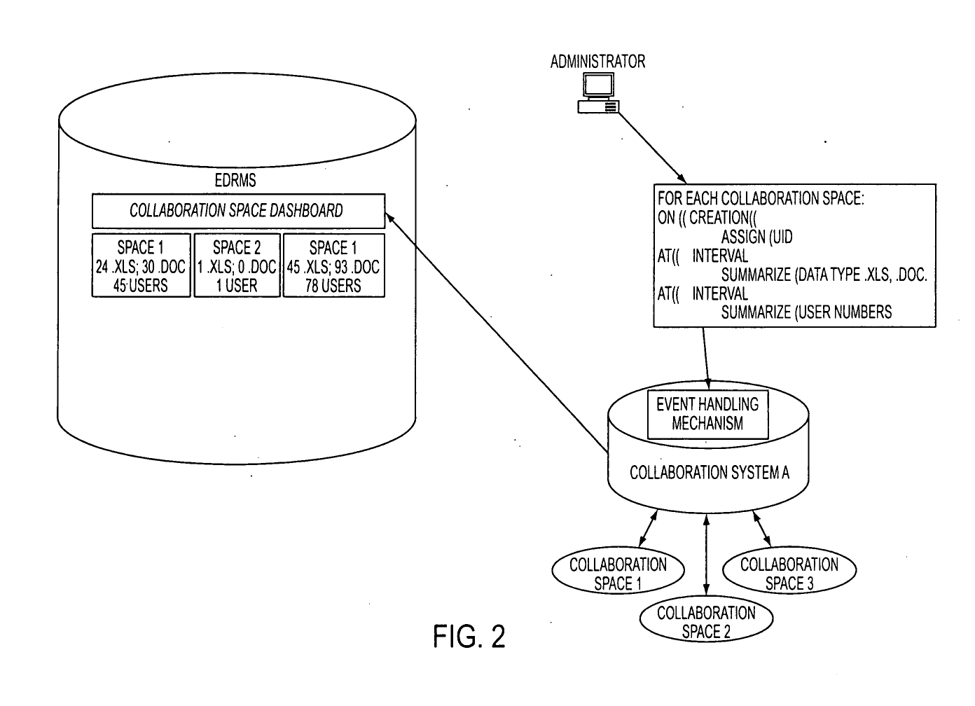

In FIG. 2, the invention is being used to create a “corporate dashboard” within the EDRMS. The Administrator has instructed the Collaboration System through the Event Handling Mechanism to assign each Collaboration Space a unique identifier, create an aggregate summary of the data contained within the Collaboration Space and monitor the level of user activity for some predefined interval. In FIG. 2, the Event Handling Mechanism assigns each Collaboration Space a unique identifier so that it may be distinguished from other similar Collaboration Spaces and additionally so that the EDRMS may identify the correct Collaboration Space when updated information is presented to it. The Event Handling Mechanism has also been instructed to summarize the types of data held in the Collaboration Space at regular, predefined intervals as well as the number of users accessing the Collaboration Space. The Event Handling Mechanism passes the Metadata to the EDRMS which then presents the data as a summary “snapshot” of the Collaboration Space. In this way, the Administrator may determine at any given time the number, nature and usage level of all Collaboration Spaces within a Collaboration System. Although not pictured, the invention is capable of managing any number of geographically diverse Collaboration Systems such as a network of Lotus Notes nodes or Microsoft SharePoint Servers. In addition to the summary management view illustrated, it will also provide a hierarchical fileplan view that allows easy navigation among Collaboration Spaces and/or Collaboration Systems.

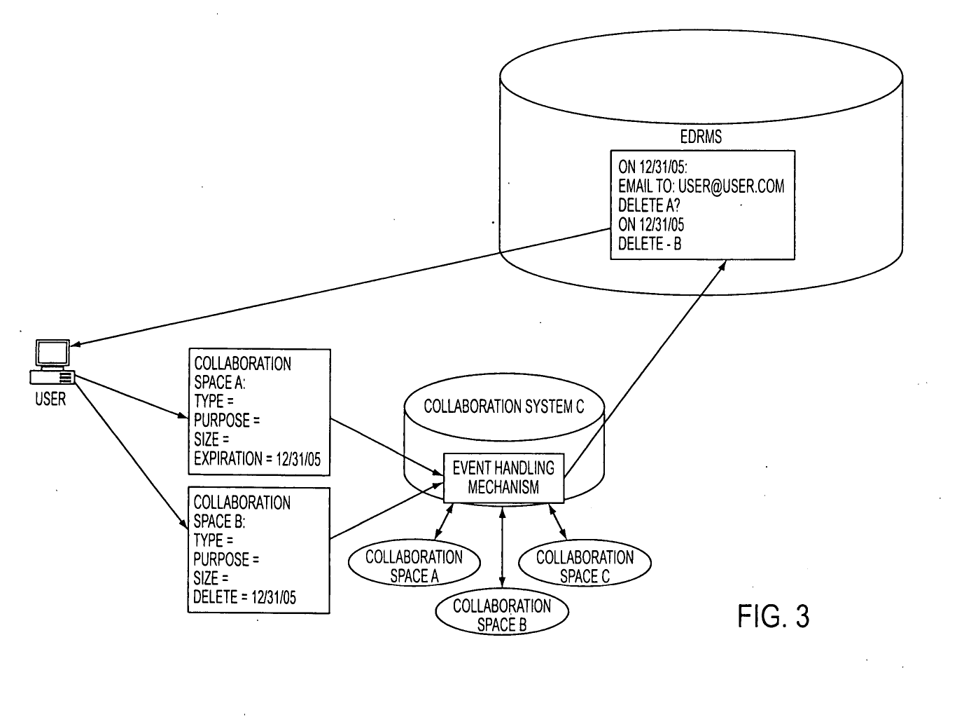

FIG. 3 shows the invention being used to automatically clean up Collaboration Spaces that are no longer needed. The User, when instructing the Collaboration System to create a particular Collaboration Space, may be presented with a template to be completed. This template contains basic information about the Collaboration Space to be created, such as the type and purpose of the Collaboration Space along with a date field. Any other suitable information may additionally or alternatively be collected. For example, in the instructions for Collaboration Space A, the Collaboration Space is set to expire on Dec. 31, 2005; in the instructions for Collaboration Space B, the Collaboration Space is to be deleted on Dec. 31, 2005.

In the case of Collaboration Space A, the Event Handling Mechanism may send information to the EDRMS which generates an e-mail to the User indicating that the expiration date for the Collaboration Space has arrived and asking the User whether or not he wishes to “reauthorize” the Collaboration Space. If the User wishes the Collaboration Space to remain active, he may use the Collaboration System to reauthorize the Collaboration Space. If he does not do so within a stated time interval, then the Collaboration Space may be automatically be deleted. Preferably, because the Collaboration Space contains only a representation of the objects contained therein, the objects themselves are not deleted.

In the case of Collaboration Space B, the Collaboration Space has been set to be automatically deleted on Dec. 31 , 2005. No user intervention is required in this case. On the given date, the Collaboration Space may be automatically deleted. Preferably, because the Collaboration Space contains only a representation of the objects contained therein, the objects themselves are not deleted.

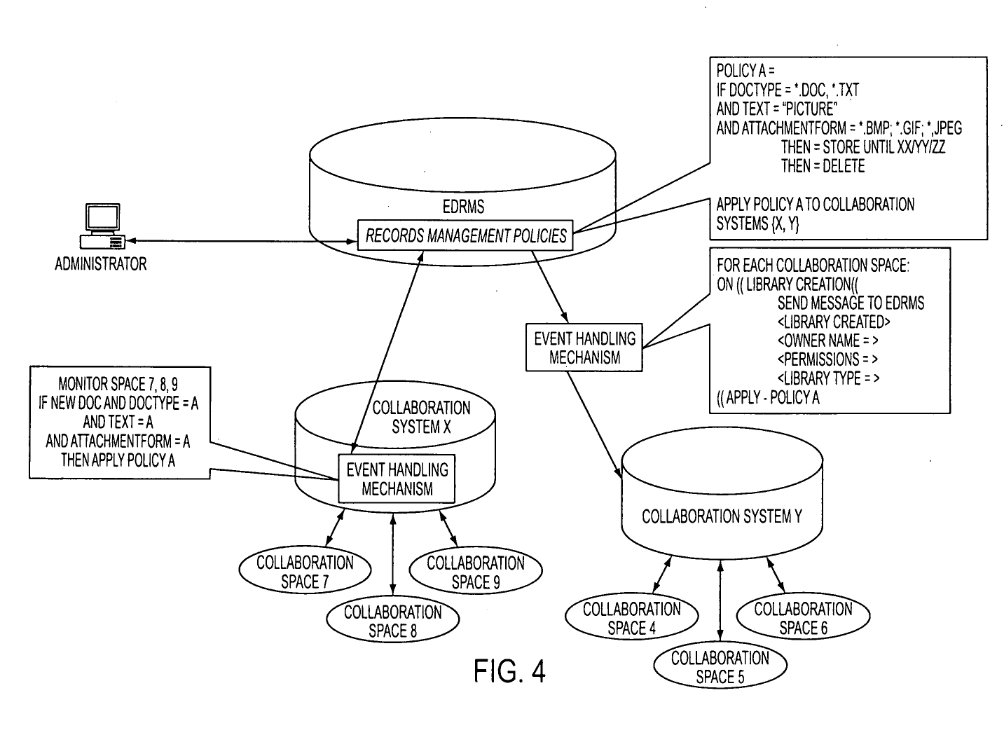

Referring now to FIG. 4, a representation of how the invention may be able to apply the Records Management Policies from the EDRMS to the individual Collaboration Spaces via the Collaboration System, where the Collaboration System has no internal Event Handling Mechanism, is illustrated. In FIG. 4, the Administrator has created a number of Records Management Policies. Policy A requires that if a particular document is created and contains specified words and attachments, it is to be stored until a certain date and then deleted.

The Administrator is then also able to specify locations where the Records Management Policy is to be applied. In FIG. 4, he has specified that the policy should be applied to Collaboration System X. The EDRMS then inserts a series of commands into the Event Handling Mechanism in Collaboration System X which instructs Collaboration System X to monitor Collaboration Spaces 7-9 for the creation of documents that meet the criteria defined in Policy A; on the creation of such a document, the Event Handling Mechanism may then apply to that document Policy A's Records Management Policies.

In FIG. 4, a representation of how the invention may be able to apply the Records Management Policies from the EDRMS to the individual Collaboration Spaces via a Collaboration System Y, where Collaboration System Y has no internal Event Handling Mechanism, is also illustrated. The mechanism may be the same as (or similar to) that in Collaboration System X but instead of instructing the Collaboration System Y's internal Event Handling Mechanism to apply the Records Management Policies, the EDRMS creates an independent Event Handling Mechanism which is then inserted into Collaboration System Y. On creation of a document meeting the specified criteria, the Event Handling Mechanism may then apply to that document A's Records Management Policies.

Other embodiments, extensions, and modifications of the ideas presented above are comprehended and should be within the reach of one versed in the art upon reviewing the present disclosure. Accordingly, the scope of the present invention in its various aspects should not be limited by the examples presented above. The individual aspects of the present invention, and the entirety of the invention should be regarded so as to allow for such design modifications and future developments within the scope of the present disclosure. The present invention is only limited by the claims which follow.

What is claimed is:

1. A method for managing a collaboration space, comprising:
defining an event related to the collaboration space; and
upon occurrence of the event, performing at least one of automatically cleaning-up the collaboration space, cataloguing the collaboration space, and updating a catalog including the collaboration space.

2. The method of claim 1, wherein cataloguing comprises:
extracting information from the collaboration space;
creating an overview of the collaboration space; and
presenting a catalogue of collaboration spaces that includes the overview of the collaboration space to a user.

3. The method of claim 1, wherein automatically cleaning-up comprises deleting the collaboration space.

4. The method of claim 3, wherein documents represented in the collaboration space are maintained after the collaboration space is deleted.

5. The method of claim 3, wherein documents represented in the collaboration space are deleted after the collaboration space is deleted.

6. The method of claim 1, wherein automatically cleaning-up comprises archiving the collaboration space.

7. The method of claim 1, further comprising sending an email to the user warning of the cleaning-up.

8. The method of claim 1, further comprising sending an email to the user warning of an expiration of the collaboration space.

9. The method of claim 1, further comprising automatically deleting a document in the collaboration space based upon a policy.

10. The method of claim 9, wherein the policy is based on the document containing a specified word.

11. The method of claim 9, wherein the policy is based on the document containing an attachment.

12. The method of claim 1, wherein the information comprises the collaboration space's usage.

13. The method of claim 1, wherein the information comprises the creation date of the collaboration space.

14. The method of claim 1, wherein the information comprises the purpose of the collaboration space.

15. The method of claim 1, wherein the information comprises the end date of the collaboration space.

16. The method of claim 1, wherein the information comprises the owner name of the collaboration space.

17. The method of claim 1, wherein the information comprises permissions of the collaboration space.

18. The method of claim 1, wherein the information comprises the type of information in the collaboration space.

19. The method of claim 1, further comprising presenting the user with a template for at least some of the information when creating the collaboration space.

20. The method of claim 1, further comprising creating an aggregate summary of the data contained within the collaboration space.

21. The method of claim 1, wherein the event is the level of user activity in the collaboration space and further comprising monitoring the level of user activity in the collaboration space.

22. The method of claim 1, wherein the event is the size of the collaboration space reaching a certain size and further comprising monitoring the size of the collaboration space.

23. The method of claim 1, wherein the event is the age of the collaboration space reaching a certain age and further comprising monitoring the age of the collaboration space.

24. A system for managing a collaboration space, comprising:
a processor that:
receives a definition of an event related to the collaboration space; and
upon occurrence of the event, performs at least one of automatically cleaning-up the collaboration space, cataloguing the collaboration space, and updating a catalog including the collaboration space.

25. The system of claim 24, wherein in cataloguing, the processor at least:
extracts information from the collaboration space;
creates an overview of the collaboration space; and
presents a catalogue of collaboration spaces that includes the overview of the collaboration space to a user.

26. The system of claim 24, wherein automatically cleaning-up comprises deleting the collaboration space.

27. The system of claim 26, wherein documents represented in the collaboration space are maintained after the collaboration space is deleted.

28. The system of claim 26, wherein documents represented in the collaboration space are deleted after the collaboration space is deleted.

29. The system of claim 24, wherein automatically cleaning-up comprises archiving the collaboration space.

30. The system of claim 24, wherein the processor also sends an email to the user warning of the cleaning-up.

31. The system of claim 24, wherein the processor also sends an email to the user warning of an expiration of the collaboration space.

32. The system of claim 24, wherein the processor also automatically deletes a document in the collaboration space based upon a policy.

33. The system of claim 32, wherein the policy is based on the document containing a specified word.

34. The system of claim 32, wherein the policy is based on the document containing an attachment.

35. The system of claim 24, wherein the information comprises the collaboration space's usage.

36. The system of claim 24, wherein the information comprises the creation date of the collaboration space.

37. The system of claim 24, wherein the information comprises the purpose of the collaboration space.

38. The system of claim 24, wherein the information comprises the end date of the collaboration space.

39. The system of claim 24, wherein the information comprises the owner name of the collaboration space.

40. The system of claim 24, wherein the information comprises permissions of the collaboration space.

41. The system of claim 24, wherein the information comprises the type of information in the collaboration space.

42. The system of claim 24, wherein the processor also presents the user with a template for at least some of the information when creating the collaboration space.

43. The system of claim 24, wherein the processor also creates an aggregate summary of the data contained within the collaboration space.

44. The system of claim 24, wherein the event is the level of user activity in the collaboration space and wherein the processor also monitors the level of user activity in the collaboration space.

45. The system of claim 24, wherein the event is the size of the collaboration space reaching a certain size and wherein the processor also monitors the size of the collaboration space.

46. The system of claim 24, wherein the event is the age of the collaboration space reaching a certain age and wherein the processor also monitors the age of the collaboration space.

47. A computer-readable medium containing computer-executable instructions that, when executed by a processor, cause the processor to perform a method for managing a collaboration space, the method comprising:
defining an event related to the collaboration space; and
upon occurrence of the event, performing at least one of automatically cleaning-up the collaboration space, cataloguing the collaboration space, and updating a catalog including the collaboration space.

48. The medium of claim 47, wherein cataloguing comprises:
extracting information from the collaboration space;
creating an overview of the collaboration space; and
presenting a catalogue of collaboration spaces that includes the overview of the collaboration space to a user.

49. The medium of claim 47, wherein automatically cleaning-up comprises deleting the collaboration space.

50. The medium of claim 49, wherein documents represented in the collaboration space are maintained after the collaboration space is deleted.

51. The medium of claim 49, wherein documents represented in the collaboration space are deleted after the collaboration space is deleted.

52. The medium of claim 47, wherein automatically cleaning-up comprises archiving the collaboration space.

53. The medium of claim 47, wherein the method further comprises sending an email to the user warning of the cleaning-up.

54. The medium of claim 47, wherein the method further comprises sending an email to the user warning of an expiration of the collaboration space.

55. The medium of claim 47, wherein the method further comprises automatically deleting a document in the collaboration space based upon a policy.

56. The medium of claim 55, wherein the policy is based on the document containing a specified word.

57. The medium of claim 55, wherein the policy is based on the document containing an attachment.

58. The medium of claim 47, wherein the information comprises the collaboration space's usage.

59. The medium of claim 47, wherein the information comprises the creation date of the collaboration space.

60. The medium of claim 47, wherein the information comprises the purpose of the collaboration space.

61. The medium of claim 47, wherein the information comprises the end date of the collaboration space.

62. The medium of claim 47, wherein the information comprises the owner name of the collaboration space.

63. The medium of claim 47, wherein the information comprises permissions of the collaboration space.

64. The medium of claim 47, wherein the information comprises the type of information in the collaboration space.

65. The medium of claim 47, wherein the method further comprises presenting the user with a template for at least some of the information when creating the collaboration space.

66. The medium of claim 47, wherein the method further comprises creating an aggregate summary of the data contained within the collaboration space.

67. The medium of claim 47, wherein the event is the level of user activity in the collaboration space and further comprising monitoring the level of user activity in the collaboration space.

68. The medium of claim 47, wherein the event is the size of the collaboration space reaching a certain size and further comprising monitoring the size of the collaboration space.

69. The medium of claim 47, wherein the event is the age of the collaboration space reaching a certain age and further comprising monitoring the age of the collaboration space.
